(19) United States
(12) Patent Application Publication
(10) Pub. No.: US 2018/0095531 A1
(43) Pub. Date: Apr. 5, 2018

(54) NON-UNIFORM IMAGE RESOLUTION RESPONSIVE TO A CENTRAL FOCUS AREA OF A USER

(71) Applicant: Lenovo Enterprise Solutions (Singapore) Pte. Ltd., Singapore (SG)

(72) Inventors: Tristian T. Brown, Raleigh, NC (US); Beverly D. Clapp, Durham, NC (US); Ray R. Engler, Cary, NC (US); Zachary R. Purser, Raleigh, NC (US)

(21) Appl. No.: 15/286,096

(22) Filed: Oct. 5, 2016

(51) Int. Cl. G06F 3/01; G06T 3/40; G09G 5/391; H04N 7/01; G06T 1/20

(52) U.S. Cl. CPC G06F 3/013; G06T 3/40; G09G 5/391; H04N 7/0127; G09G 2370/02; G06T 1/20; G09G 2354/00; G09G 2340/0435; H04N 7/0117

(57) ABSTRACT

A method includes using a camera to monitor a direction of focus of at least one eye of a person, wherein the person is facing the camera and a display screen, and determining an area of the display screen that is a central focus area based on the direction of focus of the at least one eye of the person. The method further includes obtaining an image to be displayed on the display screen, wherein the image has a first portion to be displayed within the central focus area and a second portion to be displayed outside the central focus area. Still further, the method includes displaying the first portion of the image using a first image resolution, and displaying the second portion of the image using a second image resolution, wherein the second image resolution is lower than the first image resolution.

### BACKGROUND

### Field of the Invention

The present invention relates to methods of controlling the reproduction of images on a display screen.

### Background of the Related Art

A video player is a common software application that is used by a general purpose computer to play a digital video file, such as a movie. The digital video file may be stored locally on the same computer as the video player application, perhaps on a hard disk, optical disk, or flash drive. Alternatively, the digital video file may be streamed to the local computer from a remote device, such as a video content server, third party computer or smartphone via a network. For example, a home computer with an Internet connection can access a variety of video sources and download the video content to watch on their computer screen. Optionally, the video content may be partially or fully download prior to reproducing the video on the computer screen, or the video content may be streamed to the computer with little or no buffering.

A video game console outputs a video signal similar to that of a video player, except that the video game console is primarily designed for playing video games. With a video game console, the video images are computer-generated responsive to the input received from one or more game controllers. Still, the video game software may be partially or fully resident on the video game console or a remote server, and the individuals using the game controllers may directly access the video game console or may be remotely located and require a network connection to the remote server.

Regardless of the type of images or the nature of the device producing the images, the generation of video content may require a substantial amount of resources from a graphics processing unit. Similarly, the distribution of any type of video content may consume significant network bandwidth. Techniques such as video compression may be used to reduce the size of a video file and techniques such as buffering may be used to minimize or prevent interruptions in video reproduction. However, video generation and distribution still consumes a considerable amount of resources.

### BRIEF SUMMARY

One embodiment of the present invention provides a method comprising using a camera to monitor a direction of focus of at least one eye of a person, wherein the person is facing the camera and a display screen, and determining an area of the display screen that is a central focus area based on the direction of focus of the at least one eye of the person. The method further comprises obtaining an image to be displayed on the display screen, wherein the image has a first portion to be displayed within the central focus area and a second portion to be displayed outside the central focus area. Still further, the method comprises displaying the first portion of the image using a first image resolution, and displaying the second portion of the image using a second image resolution, wherein the second image resolution is lower than the first image resolution.

Another embodiment of the present invention provides a computer program product comprising a non-transitory computer readable storage medium having program instructions embodied therewith, wherein the program instructions are executable by a processor to cause the processor to perform a method. The method comprises using a camera to monitor a direction of focus of at least one eye of a person, wherein the person is facing the camera and a display screen, and determining an area of the display screen that is a central focus area based on the direction of focus of the at least one eye of the person. The method further comprises obtaining an image to be displayed on the display screen, wherein the image has a first portion to be displayed within the central focus area and a second portion to be displayed outside the central focus area. Still further, the method comprises displaying the first portion of the image using a first image resolution, and displaying the second portion of the image using a second image resolution, wherein the second image resolution is lower than the first image resolution.

### BRIEF DESCRIPTION OF THE SEVERAL VIEWS OF THE DRAWINGS

FIG. 1 is a diagram of a computer including a display screen for viewing by a person using the computer and a camera for capturing images of the person while using the computer.

FIGS. 2A-D are illustrations of eye movement that may be detected.

FIGS. 3A-B are diagrams of a display screen illustrating high resolution areas around a detected focal point of viewing by the person using the computer.

FIG. 4 is a diagram of a computer according to one embodiment of the present invention.

FIG. 5 is a system diagram including a remote device streaming live or recorded video to a local computer according to another embodiment of the present invention.

FIG. 6 is a flowchart of a method according to a further embodiment of the present invention.

### DETAILED DESCRIPTION

One embodiment of the present invention provides a method comprising using a camera to monitor a direction of focus of at least one eye of a person, wherein the person is facing the camera and a display screen, and determining an area of the display screen that is a central focus area based on the direction of focus of the at least one eye of the person. The method further comprises obtaining an image to be displayed on the display screen, wherein the image has a first portion to be displayed within the central focus area and a second portion to be displayed outside the central focus area. Still further, the method comprises displaying the first portion of the image using a first image resolution, and displaying the second portion of the image using a second image resolution, wherein the second image resolution is lower than the first image resolution.

In one option, the camera and the display screen are integral to a laptop computer, tablet computer or smartphone. However, the camera and the display screen may also be separate components of a desktop computer, video game console or a smart television. A software application may perform face recognition to identify a face directed toward the camera and a similarly positioned display screen, then analyze images of the face to determine a central focus area of the display screen. Depending upon the camera resolution, the software application capabilities, and the proximity of the person, the accuracy of the central focus area may be determined with greater or lesser accuracy. Optionally, the size or shape of the central focus area may be manually fixed or dynamically variable to provide a suitable user experience while also providing a desired reduction in load on a graphics processor unit or bandwidth over a network. Optionally, the size of the central focus area is increased with increasing distance between the display screen and the person viewing the image on the display screen.

It should be appreciated that the area of the display screen that is determined to be the central focus area may change dynamically in response to any detected change in the direction of focus of the at least one eye of the person. For example, as an image or sequence of images are displayed on the display screen, the camera continues to monitor the direction of focus of the at least one eye of a person and determine an area of the display screen that is currently a central focus area. It is expected that the central focus area will change dynamically as the person scans their focus across the image or as one or more elements in the image move within the area of the display screen.

A data file that stored the image, such as a digital video file, will typically have a single, fixed image resolution. Embodiments of the present invention may reduce the image resolution in the second portion of the image that is outside the central focus area for the purpose of either reducing a load on a graphics processing unit or reducing the bandwidth required to stream the image from a remote device. The first portion of the image will preferably be displayed at the full resolution of the data file. However, the method may also reduce the image resolution in the first portion so long as the image resolution in the second portion is reduced to a lower image resolution than the first portion. Accordingly, the higher image resolution of the first portion provides greater image detail to the person in the area of that is their current focus, while the lower image resolution of the second portion provides reduced resource consumption in areas that are not their current focus. As the person's focus shifts to another area of the display screen, the first portion also shift so that the higher image resolution is always displayed in the area of the person's focus.

In certain embodiments, the image may include a sequence of video images, such as those found in a typical video content file. In one option, the video images may be obtained from a data storage device of a local computer that is directly attached to the display screen, such that displaying the second portion of the image using a second image resolution will reduce the total amount of data processing required by a graphics processor unit of the local computer to display the video images. Furthermore, the second portion of the image may be displayed using a second (lower) image resolution in response to detecting that the graphics processor unit is performing above a predetermined threshold. In other words, a graphics processor unit bottleneck may be detected and avoid by initiating a non-uniform image resolution embodiment of the present invention. In yet another option, the method may save data identifying the central focus area from a first instance of displaying the image on the display screen and, during a second instance of displaying the image on the display screen, display the image using the saved data identifying the central focus area.

In other embodiments where the image includes a sequence of video images, the method may further include displaying the first portion of the video images using a first refresh rate, and displaying the second portion of the video images using a second refresh rate, wherein the second refresh rate is lower than the first refresh rate. Using a lower refresh rate of a portion of the video image will further reduce the resource consumption attributable to areas of the display screen that are not the person's current focus.

In various embodiments, the image may include a sequence of video images that are obtained as streaming video from a remote device. For example, the streaming video may be live video that is displayed on the display screen without buffering. In this situation, streaming video is sent from the remote device to the local computer over a network, thereby utilizing a certain amount of network bandwidth. In one option, the method may further include sending data identifying the central focus area of the display screen from the local computer to the remote device, and the remote device sending the streaming video to the local computer with the first portion of the image using the first image resolution and the second portion of the image using the second image resolution. By sending the streaming video with the first portion of the image using the first image resolution and the second portion of the image using the second (reduced) image resolution, the bandwidth utilized to send the streaming video over a network to the local computer will be reduced. Optionally, the step of sending the streaming video with the first portion of the image using the first image resolution and the second portion of the image using the second image resolution may be initiated in response to detecting that the network is being utilized above a predetermined threshold. In other words, a potential network bottleneck may be detected and avoid by initiating a non-uniform image resolution embodiment of the present invention. In a separate option, the method may save data that identifies the person's central focus area from a first instance of displaying the image on the display screen and, during a second instance of displaying the image on the display screen, display the image using the saved data identifying the central focus area.

Another embodiment of the present invention provides a computer program product comprising a non-transitory computer readable storage medium having program instructions embodied therewith, wherein the program instructions are executable by a processor to cause the processor to perform a method. The method comprises using a camera to monitor a direction of focus of at least one eye of a person, wherein the person is facing the camera and a display screen, and determining an area of the display screen that is a central focus area based on the direction of focus of the at least one eye of the person. The method further comprises obtaining an image to be displayed on the display screen, wherein the image has a first portion to be displayed within the central focus area and a second portion to be displayed outside the central focus area. Still further, the method comprises displaying the first portion of the image using a first image resolution, and displaying the second portion of the image using a second image resolution, wherein the second image resolution is lower than the first image resolution.

The foregoing computer program products may further include program instructions for implementing or initiating any one or more aspects of the methods described herein. Accordingly, a separate description of the methods will not be duplicated in the context of a computer program product.

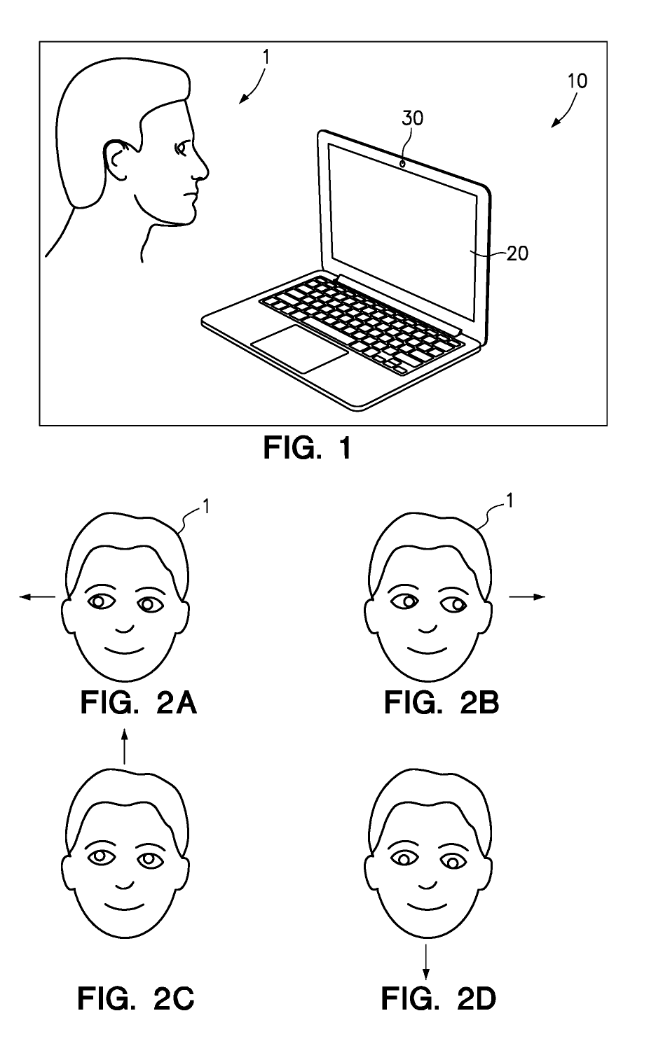

FIG. 1 is a diagram of a computer 10 including a display screen 20 for viewing by a person 1 using the computer and a camera 30 for capturing images of the person while using the computer. While the computer 10 is shown as a laptop computer, embodiments of the invention may be implemented in various other forms, such as desktop computer, tablet computer, smartphone, video game console and smart television. As shown, the camera 30 is conveniently positioned adjacent the top of the display screen 20, such that the person 1 is facing the camera 30 while viewing the display screen 20. Accordingly, the camera 30 is able to capture images of the person's eyes and the person's focus moves from one portion of the display screen to another.

FIGS. 2A-D are non-limiting illustrations of eye movements that may be detected. In FIG. 2A, an image captured by the camera shows that the person 1 has their eyes focused to the left (i.e., the person's right). In FIG. 2B, it may be determined that the person 1 has their eyes focused to the right (i.e., the person's left). In FIG. 2C the person 1 has their eyes focused upward and in FIG. 2D the person 1 has their eyes focused downward. It should be appreciated that the person's focus may be left, right, up and/or down to a greater or lesser extent, such that the direction of the person's eyes may be used to determine a central focus area that may be anywhere on the display screen.

Depending upon the camera resolution, the software application capabilities, and the proximity of the person from the camera and the display screen, the accuracy of the central focus area may be determined with greater or lesser accuracy. For example, one embodiment might only distinguish between four possible central focus areas (i.e., left, right, top and bottom; or upper-left, upper-right, lower-left and lower-right), while another embodiment might determine a precise pixel that is the center of the person's focus and calculate an central focus area as a function of the pixel location (central focus point). For example a central focus area could have a given radius about a central focus point or have any shape with the central focus point as its centroid.

Optionally, the size or shape of the central focus area may be manually fixed or dynamically variable to provide a suitable user experience while also providing a desired reduction in load on a graphics processor unit or bandwidth over a network. Optionally, the size of the central focus area is increased with increasing distance between the display screen and the person viewing the image on the display screen.

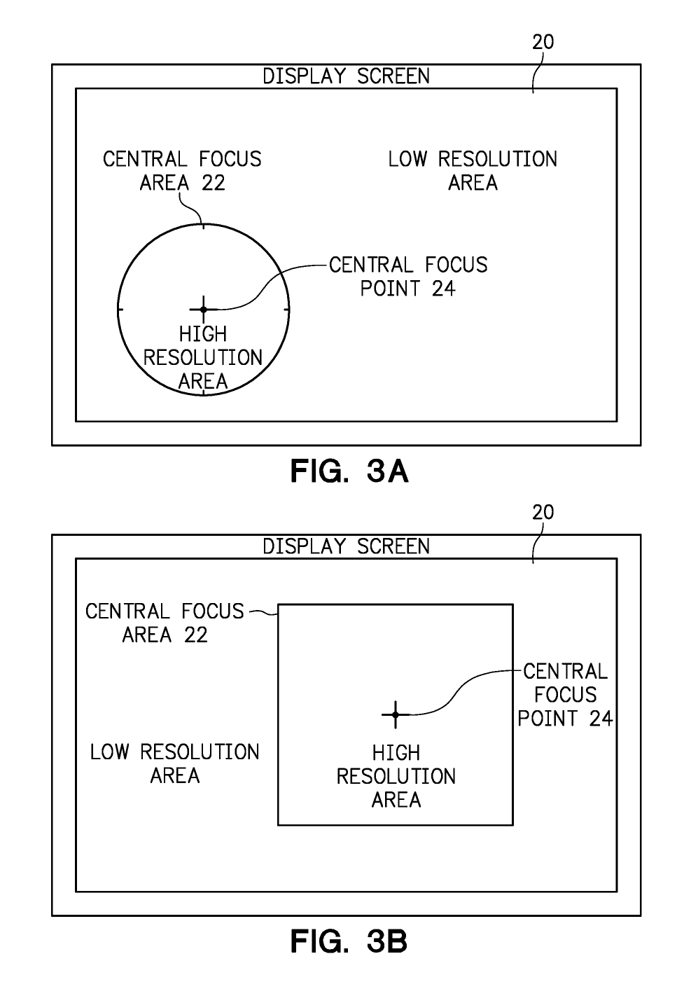

FIGS. 3A-B are diagrams of the display screen 20 illustrating a central focus point area 22 around a detected central focus point 24 of the person using the computer. Accordingly, an image being displayed on the display screen 20 will have a high resolution within the central focus area 22 and a low resolution outside of the central focus area. In FIG. 3A, the central focus area 22 is a circular shape with the central focus point 24 at the center. In FIG. 3B, the central focus area 22 is a rectangular shape with the central focus point 24 at the center. The difference is size and shape of the central focus areas in FIG. 3A and FIG. 3B may be the result of a user preference setting, a parameter associated with the image file, or a detected distance of the person from the camera or display screen. In the later instance, a person at a greater distance from the display screen will tend to have a larger area with their field of view. In either of the FIGS. 3A-B, the low resolution area is greater than half of the display screen, such that the load on a graphics processor to generate the image and/or the network bandwidth utilized to distribute the image will be significantly reduced. A high load on a graphics processing unit may be associated with running a gaming application or a graphics program with three-dimensional visualization output. By contrast, network bandwidth may reach a high degree of utilization when transmitting video for a teleconference.

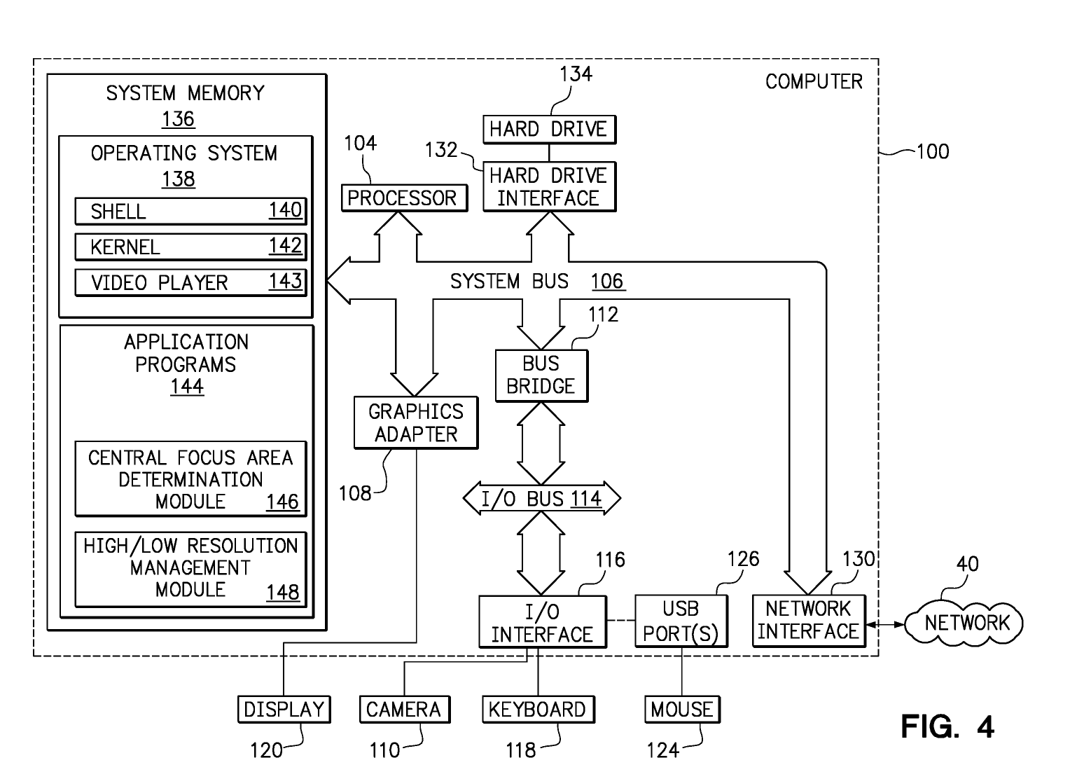

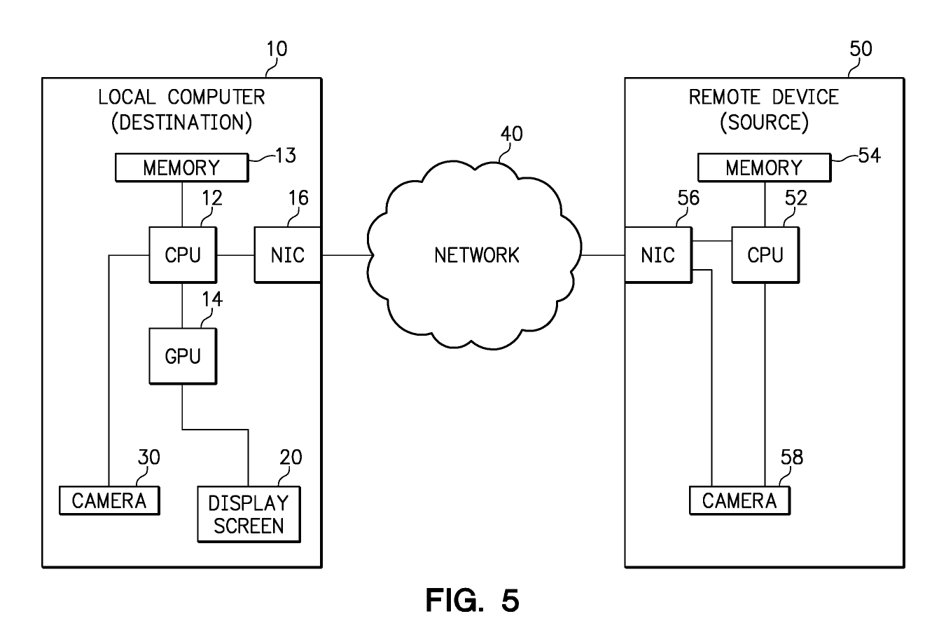

FIG. 4 is a diagram of a 100 that is representative of the computer 10 of FIG. 1 and/or the remote device 50 shown in FIG. 5 according to one embodiment of the present invention. The computer 100 includes a processor unit 104 that is coupled to a system bus 106. The processor unit 104 may utilize one or more processors, each of which has one or more processor cores. A graphics adapter 108, which drives/supports a display 120, is also coupled to system bus 106. The graphics adapter 108 may, for example, include a graphics processing unit (GPU). The system bus 106 is coupled via a bus bridge 112 to an input/output (I/O) bus 114. An I/O interface 116 is coupled to the I/O bus 114. The I/O interface 116 affords communication with various I/O devices, including a camera 110, a keyboard 118, and a USB mouse 124 via USB port(s) 126. As depicted, the computer 100 is able to communicate with other network devices over the network 40 using a network adapter or network interface controller 130.

A hard drive interface 132 is also coupled to the system bus 106. The hard drive interface 132 interfaces with a hard drive 134. In a preferred embodiment, the hard drive 134 communicates with system memory 136, which is also coupled to the system bus 106. System memory is defined as a lowest level of volatile memory in the computer 100. This volatile memory includes additional higher levels of volatile memory (not shown), including, but not limited to, cache memory, registers and buffers. Data that populates the system memory 136 includes the operating system (OS) 138 and application programs 144.

The operating system 138 includes a shell 140 for providing transparent user access to resources such as application programs 144. Generally, the shell 140 is a program that provides an interpreter and an interface between the user and the operating system. More specifically, the shell 140 executes commands that are entered into a command line user interface or from a file. Thus, the shell 140, also called a command processor, is generally the highest level of the operating system software hierarchy and serves as a command interpreter. The shell provides a system prompt, interprets commands entered by keyboard, mouse, or other user input media, and sends the interpreted command(s) to the appropriate lower levels of the operating system (e.g., a kernel 142) for processing. Note that while the shell 140 may be a text-based, line-oriented user interface, the present invention may support other user interface modes, such as graphical, voice, gestural, etc.

As depicted, the operating system 138 also includes the kernel 142, which includes lower levels of functionality for the operating system 138, including providing essential services required by other parts of the operating system 138 and application programs 144. Such essential services may include memory management, process and task management, disk management, and mouse and keyboard management. The operating system 138 may further include a video player 143, although the video player may be a separate application program.

As shown, the computer 100 includes application programs 144 in the system memory of the computer 100, including, without limitation, a central focus area determination module 146 and a high/low resolution management module 148 in order to implement one or more of the embodiments disclosed herein. Optionally, one or more aspect of the modules 146, 148 may be implemented as part of the video player 143.

The hardware elements depicted in the computer 100 are not intended to be exhaustive, but rather are representative. For instance, the computer 100 may include alternate memory storage devices such as magnetic cassettes, digital versatile disks (DVDs), Bernoulli cartridges, and the like. These and other variations are intended to be within the scope of the present invention.

FIG. 5 is a system diagram including a remote device 50 streaming live or recorded video over a network 40 to a local computer 10 according to another embodiment of the present invention. Without limiting the scope of the invention, one example of the local computer 10 and the remote device 50 are shown. The local computer 10 includes a central processing unit (CPU) 12, memory 13, a graphics processing unit (GPU) 14 coupled to the display screen 20, a network interface controller (MC) 16, and a camera 30. The remote device 50 includes a central processing unit (CPU) 52, memory 54, a network interface controller (NIC) 56, and a camera 58.

In one embodiment, a video file is stored in the memory 13 of the local computer 10, such that a video player application running on the CPU 12 may cause the GPU 14 to generate video frames to the display screen 20. If the GPU 14 is experiencing a load greater than a threshold load (i.e., a high load setpoint), then the camera 30 captures images of a person viewing the display screen 20 so that an application program according to the present invention may determine a central focus area. By providing the central focus area to the GPU 14, the display screen may display the video or other images having a first image resolution within the central focus area and a second (lower) image resolution outside the central focus area. Displaying a portion of the video or other image at a low resolution reduces the load on the CPU 14.

In another embodiment, video may be streamed from the remote device 50 to the local computer 10 for viewing on the display screen 20. The video may stream from a file stored in the memory 54 or may be a live video feed from the camera 58. If the network is becoming congested, perhaps as evidenced by exceeding a threshold amount of network traffic or falling below a threshold network speed, the camera 30 of the local computer 10 captures images of a person viewing the display screen 20 so that an application program according to the present invention may determine a central focus area. The central focus area is then sent over the network 40 to the remote device 50, where the streaming video is subsequently transmitted over the network 40 with the streaming video or other images having a first image resolution within the central focus area and a second (lower) image resolution outside the central focus area. As a person changes their focus on the display screen 20, the camera 30 detects this change such that the local computer 10 updates the central focus area that is provided to the remote device 50. While the portion of the streaming video that is in the central focus area may change, the total bandwidth of the streaming video is reduced because a portion of the video is sent with a lower image resolution (i.e., less data).

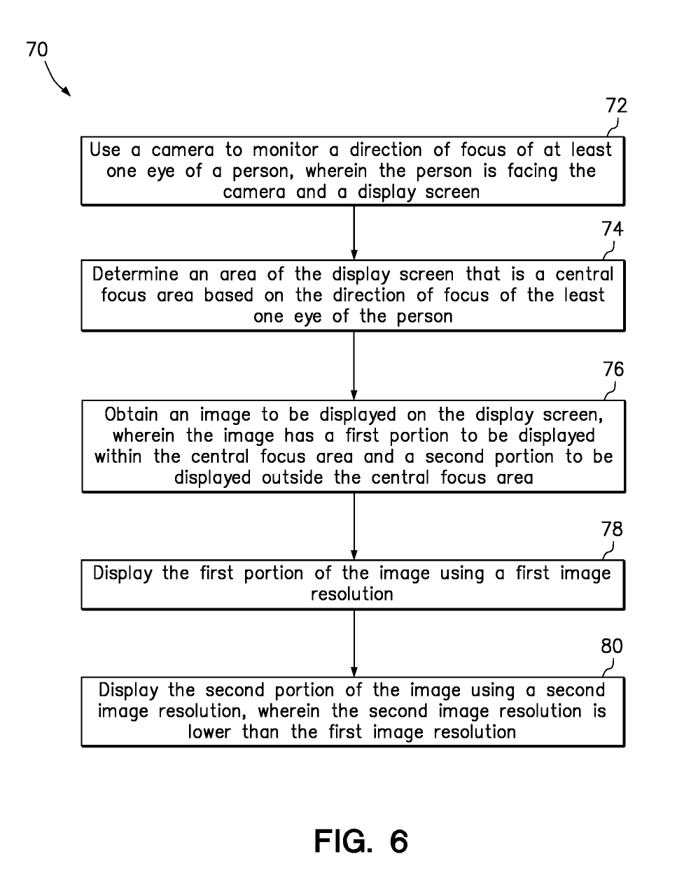

FIG. 6 is a flowchart of a method 70 according to a further embodiment of the present invention. In step 72, the method uses a camera to monitor a direction of focus of at least one eye of a person, wherein the person is facing the camera and a display screen. In step 74, the method determines an area of the display screen that is a central focus area based on the direction of focus of the at least one eye of the person. Step 76 obtains an image to be displayed on the display screen, wherein the image has a first portion to be displayed within the central focus area and a second portion to be displayed outside the central focus area. The method then displays the first portion of the image using a first image resolution in step 78 and displays the second portion of the image using a second image resolution in step 80, wherein the second image resolution is lower than the first image resolution. It should be recognized that the method is not limited to performing these steps in the order shown. For example, step 78 and step 80 may be performed simultaneously, and step 76 may be performed at any point prior to steps 78 and 80.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable storage medium(s) may be utilized. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: a portable computer diskette, a hard disk, a random access memory (RAM), a read-only memory (ROM), an erasable programmable read-only memory (EPROM or Flash memory), a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device. Furthermore, any program instruction or code that is embodied on such computer readable storage medium (including forms referred to as volatile memory) is, for the avoidance of doubt, considered “non-transitory”.

Program code embodied on a computer readable storage medium may be transmitted using any appropriate medium, including but not limited to wireless, wireline, optical fiber cable, RF, etc., or any suitable combination of the foregoing. Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention may be described with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, and/or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored as non-transitory program instructions in a computer readable storage medium that can direct a computer, other programmable data processing apparatus, or other devices to function in a particular manner, such that the program instructions stored in the computer readable storage medium produce an article of manufacture including non-transitory program instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, components and/or groups, but do not preclude the presence or addition of one or more other features, integers, steps, operations, elements, components, and/or groups thereof. The terms “preferably,” “preferred,” “prefer,” “optionally,” “may,” and similar terms are used to indicate that an item, condition or step being referred to is an optional (not required) feature of the invention.

The corresponding structures, materials, acts, and equivalents of all means or steps plus function elements in the claims below are intended to include any structure, material, or act for performing the function in combination with other claimed elements as specifically claimed. The description of the present invention has been presented for purposes of illustration and description, but it is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

What is claimed is:

1. A method, comprising:
using a camera to monitor a direction of focus of at least one eye of a person, wherein the person is facing the camera and a display screen;
determining an area of the display screen that is a central focus area based on the direction of focus of the at least one eye of the person;
obtaining an image to be displayed on the display screen, wherein the image has a first portion to be displayed within the central focus area and a second portion to be displayed outside the central focus area;
displaying the first portion of the image using a first image resolution; and
displaying the second portion of the image using a second image resolution, wherein the second image resolution is lower than the first image resolution.

2. The method of claim 1, wherein the area of the display screen that is determined to be the central focus area changes dynamically with changes in the direction of focus of the at least one eye of the person.

3. The method of claim 1, wherein displaying the second portion of the image using a second image resolution reduces the total amount of data required to display the image.

4. The method of claim 1, wherein the image comprises a sequence of video images.

5. The method of claim 4, further comprising:
displaying the first portion of the video images using a first refresh rate; and
displaying the second portion of the video images using a second refresh rate, wherein the second refresh rate is lower than the first refresh rate.

6. The method of claim 4, wherein the video images are obtained from a data storage device of a computer that is directly attached to the display screen, and wherein displaying the second portion of the image using a second image resolution reduces the total amount of data processing required by a graphics processor unit of the computer to display the video images.

7. The method of claim 6, wherein the second portion of the image is displayed using a second image resolution in response to detecting that the graphics processor unit is performing above a predetermined threshold.

8. The method of claim 6, further comprising:
saving data identifying the central focus area from a first instance of displaying the image on the display screen; and
displaying, during a second instance of displaying the image on the display screen, the image using the saved data identifying the central focus area.

9. The method of claim 4, wherein the video images are obtained as streaming video from a remote device.

10. The method of claim 9, further comprising:
sending data identifying the central focus area of the display screen to the remote device; and
the remote device sending the streaming video with the first portion of the image using the first image resolution and the second portion of the image using the second image resolution.

11. The method of claim 10, wherein sending the streaming video with the first portion of the image using the first image resolution and the second portion of the image using the second image resolution reduces the bandwidth utilized to send the streaming video over a network to the computer.

12. The method of claim 11, wherein the streaming video is sent with the first portion of the image using the first image resolution and the second portion of the image using the second image resolution in response to detecting that the network is being utilized above a predetermined threshold.

13. The method of claim 11, further comprising:
saving data identifying the central focus area from a first instance of displaying the image on the display screen; and
displaying, during a second instance of displaying the image on the display screen, the image using the saved data identifying the central focus area.

14. The method of claim 11, wherein the streaming video is a live video.

15. The method of claim 14, wherein the streaming video is displayed on the display screen without buffering.

16. A computer program product comprising a non-transitory computer readable storage medium having program instructions embodied therewith, the program instructions executable by a processor to cause the processor to perform a method comprising:
using a camera to monitor a direction of focus of at least one eye of a person, wherein the person is facing the camera and a display screen;
determining an area of the display screen that is a central focus area based on the direction of focus of the at least one eye of the person;
obtaining an image to be displayed on the display screen, wherein the image has a first portion to be displayed within the central focus area and a second portion to be displayed outside the central focus area;
displaying the first portion of the image using a first image resolution; and
displaying the second portion of the image using a second image resolution, wherein the second image resolution is lower than the first image resolution.

17. The computer program product of claim 16, wherein determining an area of the display screen that is a central focus area based on the direction of focus of the at least one eye of the person, including dynamically determining the area of the display screen that is the central focus area based on changes in the direction of focus of the at least one eye of the person.

18. The computer program product of claim 16, wherein the image comprises a sequence of video images, wherein the video images are obtained from a data storage device of a computer that is directly attached to the display screen, and wherein displaying the second portion of the image using a second image resolution reduces the total amount of data processing required by a graphics processor unit of the computer to display the video images.

19. The computer program product of claim 16, wherein the image comprises a sequence of video images obtained as streaming video from a remote device, the method further comprising:
sending data identifying the central focus area of the display screen to the remote device; and
the remote device sending the streaming video with the first portion of the image using the first image resolution and the second portion of the image using the second image resolution.

20. The computer program product of claim 19, wherein sending the streaming video with the first portion of the image using the first image resolution and the second portion of the image using the second image resolution reduces the bandwidth utilized to send the streaming video over a network to the computer.
